(19) United States
(12) Patent Application Publication
(10) Pub. No.: US 2023/0058868 A1
(43) Pub. Date: Feb. 23, 2023

(54) INJECTION MOLDING MACHINE

(71) Applicant: FANUC CORPORATION, Yamanashi (JP)

(72) Inventor: Keisuke SUGAHARA, Yamanashi-ken (JP)

(21) Appl. No.: 17/797,125

(22) PCT Filed: Feb. 1, 2021
(86) PCT No.: PCT/JP2021/003446

§ 371 Date: Aug. 3, 2022

(30) Foreign Application Priority Data
Feb. 5, 2020 (JP) 2020-017623

(51) Int. Cl. B29C 45/13; B29C 45/17; B29C 45/80

(52) U.S. Cl. CPC B29C 45/13; B29C 45/80; B29C 45/1747

(57) ABSTRACT

Provided is an injection molding machine that can reduce variations in the position of a slider with respect to a prescribed position. An injection molding machine of one embodiment comprise: a second injection device as an injection device for injecting a resin to a mold from a direction intersecting an extension direction in which a tie bar extends; a slider that supports the second injection device and slides same along the extension direction with respect to a fixed platen; and an adjuster that is disposed on a side of the fixed platen opposite to side where the mold is disposed, that regulates the slider so that the slider does not slide, with respect to the fixed platen, beyond the prescribed position in a mold opening direction of the mold, and that is capable of adjusting the prescribed position in the extension direction.

### TECHNICAL FIELD

The present invention relates to an injection molding machine that opens and closes a mold, by causing a movable platen to move with respect to a stationary platen along a tie bar that is connected to the stationary platen.

### BACKGROUND ART

As disclosed in JP 2017-132226 A, an injection molding machine may be equipped with an injection device that injects a resin from a direction that intersects with a direction of extension (a mold opening and closing direction) in which a tie bar extends. According to JP 2017-132226 A, the injection device is supported by a slider (base member). The slider is attached to the stationary platen so as to be slidable along the direction of extension (the mold opening and closing direction) in which the tie bar extends. An injection position of the injection device with respect to the mold is adjusted by an operator causing the slider to slide.

### SUMMARY OF THE INVENTION

Incidentally, when an operation such as inspection or replacement or the like of the mold is carried out, the operator causes the slider to slide, thereby separating the injection device from the mold. Therefore, after the operation such as inspection or replacement or the like of the mold is completed, it is necessary for the operator to cause the slider to slide to a specified position, in a manner so that the injection position of the injection device is returned to its original position. However, a problem arises in that, depending on the skill of the operator, the position of the slider tends to vary with respect to the specified position.

Thus, the present invention has the object of providing an injection molding machine, which is capable of reducing variations in the position of the slider with respect to a specified position.

An aspect of the present invention is characterized by an injection molding machine configured to open and close a mold by moving a movable platen relative to a stationary platen along a tie bar that is connected to the stationary platen, the injection molding machine including an injection device configured to inject a resin into the mold from a direction that intersects with a direction of extension in which the tie bar extends, a slider configured to support the injection device and to slide relative to the stationary platen along the direction of extension, and an adjustment tool disposed on a side of the stationary platen opposite to a side on which the mold is disposed, the adjustment tool being configured to restrict movement of the slider in a manner so that the slider does not slide, relative to the stationary platen, in a mold opening direction of the mold beyond a specified position, the adjustment tool being also configured to adjust the specified position in the direction of extension.

According to the aspect of the present invention, even if the slider is made to slide away from the mold, the slider is capable of being returned to the specified position by the adjustment tool, and as a result, variations in the position of the slider with respect to the specified position can be reduced.

### BRIEF DESCRIPTION OF THE DRAWINGS

FIG. 1 is a schematic view showing the configuration of an injection molding machine;

FIG. 2 is a schematic view showing a side surface of the injection molding machine;

FIG. 3 is a schematic view showing a portion of the side surface of the injection molding machine according to the present embodiment;

FIG. 4 is a view showing a case in which a rod-shaped member is a screw with scale;

FIG. 5 is a schematic view showing a situation in which a second injection device is retracted;

FIG. 6 is a schematic view of a portion of a side surface of the injection molding machine according to a first modification;

FIG. 7 is a schematic view of a portion of a side surface of the injection molding machine according to a second modification;

FIG. 8 is a diagram showing a case in which the slider includes a scale; and

FIG. 9 is a schematic view showing an injection molding machine according to a third modification.

### DESCRIPTION OF THE INVENTION

### Embodiment

### Configuration of Injection Molding Machine

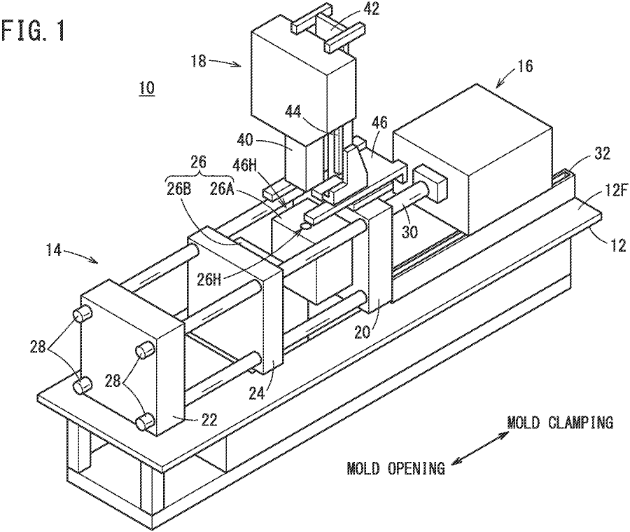

FIG. 1 is a schematic view showing the configuration of an injection molding machine 10. The injection molding machine 10 is equipped with a machine base 12, a mold clamping device 14, a first injection device 16, and a second injection device 18.

The mold clamping device 14 includes a stationary platen 20, a rear platen 22, a movable platen 24, and a mold 26.

The stationary platen 20 and the rear platen 22 are installed at an interval from each other on an installation surface 12F of the machine base 12 of the injection molding machine 10. The movable platen 24 is arranged between the stationary platen 20 and the rear platen 22. The mold 26 is constituted by a fixed mold 26A and a movable mold 26B. The fixed mold 26A is mounted on a surface of the stationary platen 20 that faces toward the movable platen 24. The movable mold 26B is mounted on a surface of the movable platen 24 that faces toward the stationary platen 20.

Each of a plurality of tie bars 28 penetrates through the movable platen 24. Each of the plurality of tie bars 28 is a rod-shaped member that is connected respectively to each of the stationary platen 20 and the rear platen 22. Moreover, the direction of extension in which the tie bars 28 extend includes opposing directions, i.e., a first direction from one end toward another end of the tie bars 28, and a second direction from the other end toward the one end of the tie bars 28. One of the first direction and the second direction is a mold opening direction of the mold 26, and the other of the first direction and the second direction is a mold clamping direction of the mold 26. In other words, the direction of extension in which the tie bars 28 extend include the opposing directions, i.e., the mold opening direction and the mold clamping direction.

A non-illustrated platen driving mechanism that drives the movable platen 24 is provided on the movable platen 24. The platen driving mechanism drives the movable platen 24 in the mold clamping direction in accordance with a forward rotation (or reverse rotation) of a motor. Further, the platen driving mechanism drives the movable platen 24 in the mold opening direction in accordance with a reverse rotation (or forward rotation) of the motor.

In the case that the platen driving mechanism drives the movable platen 24 in the mold clamping direction, the movable platen 24 moves along the plurality of tie bars 28 in the mold clamping direction. In accordance with the movement of the movable platen 24, the movable mold 26B is placed in contact with the fixed mold 26A, thereby closing the mold 26. When the mold 26 is closed, a cavity is formed in the mold 26. A molten resin, which is injected from the first injection device 16 and the second injection device 18, is filled into the cavity. It should be noted that the molten resin is a resin which is in a molten state.

On the other hand, in the case that the platen driving mechanism drives the movable platen 24 in the mold opening direction, the movable platen 24 moves along the plurality of tie bars 28 in the mold opening direction. In accordance with the movement of the movable platen 24, the movable mold 26B is separated away from the fixed mold 26A, thereby opening the mold 26. When the movable mold 26B is moved away from the fixed mold 26A and reaches a position that is spaced away from the fixed mold 26A by a predetermined distance, the molded product becomes capable of being taken out from the cavity of the mold 26. It should be noted that the molded product is obtained due to the molten resin being solidified.

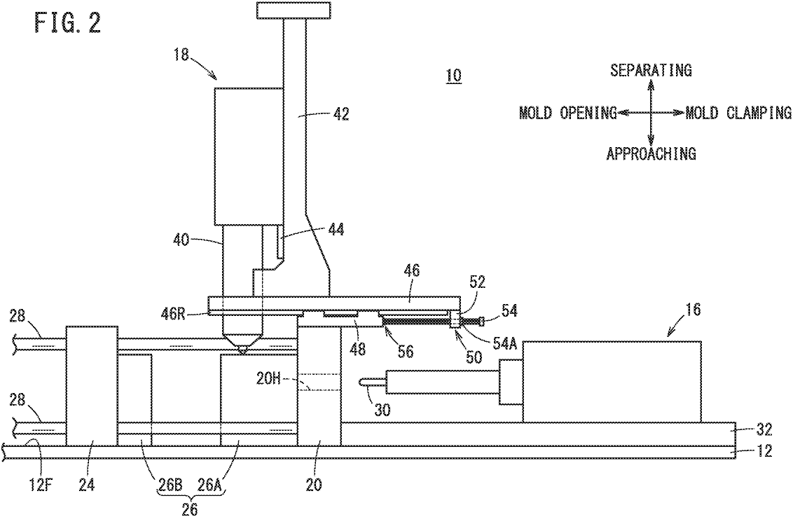

FIG. 2 is a schematic view showing a side surface of the injection molding machine 10. The first injection device 16 is an injection device that injects a resin into the mold 26 along the direction of extension in which the tie bars 28 extend. The first injection device 16 is provided at an end face side of the stationary platen 20 opposite to another end face side where the fixed mold 26A is disposed (i.e., provided rearwardly of the mold 26). The first injection device 16 includes an injection nozzle 30 which extends from an end face thereof that faces toward the stationary platen 20, along the mold opening direction of the mold 26. A penetrating hole 20H into which a tip of the injection nozzle 30 is inserted is formed in the stationary platen 20. The penetrating hole 20H is formed along the direction of extension in which the tie bars 28 extend, and communicates with the cavity in the mold 26.

The first injection device 16 moves along a guide rail 32 that is provided on the installation surface 12F of the machine base 12. The first injection device 16 is moved by the operator. Alternatively, the first injection device 16 may be moved by the driving mechanism that drives the first injection device 16 in the mold opening direction or the mold clamping direction in accordance with the rotation of a motor. The first injection device 16 is locked at a position where the tip of the injection nozzle 30 is inserted into the penetrating hole 20H of the stationary platen 20.

The second injection device 18 is an injection device that injects a resin into the mold 26 along a direction intersecting with the direction of extension in which the tie bars 28 extend. The second injection device 18 is provided at a side of the mold 26 opposite to another side where the installation surface 12F of the machine base 12 is present (i.e., provided upwardly of the mold 26). The second injection device 18 includes an injection nozzle 40 which extends from an end face thereof that faces toward the mold 26, toward the installation surface 12F. An insertion port 26H (see FIG. 1) into which a tip of the injection nozzle 40 is inserted is formed in the mold 26. The insertion port 26H communicates with the cavity in the mold 26.

Moreover, the insertion port 26H may be formed in the fixed mold 26A, may be formed in the movable mold 26B, or may be formed in both the fixed mold 26A and the movable mold 26B. In FIG. 1, a case is shown in which the insertion port 26H is formed in the fixed mold 26A.

The second injection device 18 is attached to a support member 42 that supports the second injection device 18. A guide rail 44 is provided on an end surface of the support member 42 that faces in the mold opening direction. A direction from one end toward the other end of the guide rail 44 is an approaching direction that approaches toward the mold 26, and a direction from the other end toward the one end of the guide rail 44 is a separating direction that separates away from the mold 26. The second injection device 18 moves along the guide rail 44. The second injection device 18 is moved by the operator. Alternatively, in accordance with the rotation of a motor, the second injection device 18 may be moved by the driving mechanism that drives the second injection device 18 in the approaching direction or in the separating direction. The second injection device 18 is locked at a position where the tip of the injection nozzle 40 is inserted into the insertion port 26H of the mold 26.

The support member 42 is installed on a slider 46. The slider 46 serves as a base that supports the second injection device 18. The slider 46 includes an opening 46H (see FIG. 1) through which the injection nozzle 40 of the second injection device 18 passes. A guide rail 46R, which extends along the direction of extension in which the tie bars 28 extend, is provided on a surface of the slider 46 opposite to the installation surface on which the support member 42 is installed. A slider supporting member 48 is fitted onto the guide rail 46R. The slider supporting member 48 supports the slider 46 slidably along the guide rail 46R. Therefore, the slider 46 is configured to slide the second injection device 18 relative to the stationary platen 20 along the direction of extension in which the tie bars 28 extend. The slider 46 is slid by the operator. Alternatively, the slider 46 may be moved by a driving mechanism that drives the slider 46 in a direction along the direction of extension in which the tie bars 28 extend, in accordance with the rotation of a motor.

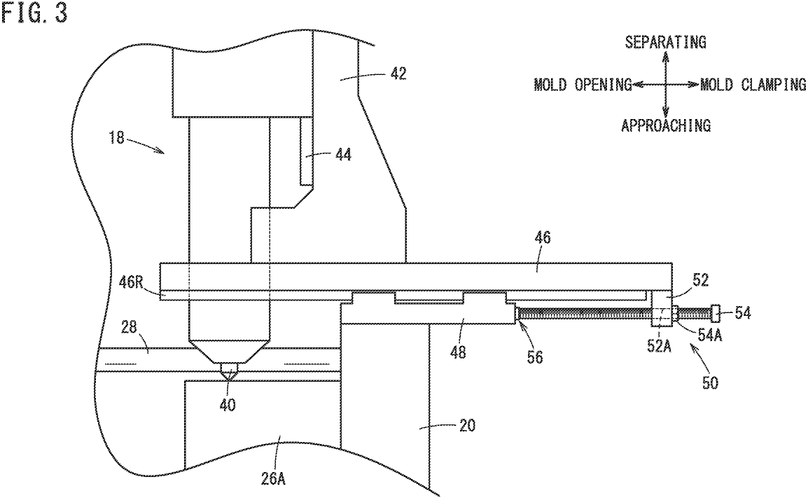

The injection molding machine 10 according to the present embodiment is further equipped with an adjustment tool 50. The adjustment tool 50 is arranged on a side of the stationary platen 20 opposite to the side on which the mold 26 is provided. FIG. 3 is a schematic view showing a portion of the side surface of the injection molding machine 10 according to the present embodiment.

The adjustment tool 50 restricts movement of the slider 46 in a manner so that the slider 46 does not slide with respect to the stationary platen 20 in the mold opening direction of the mold 26 beyond a specified position. Further, the adjustment tool 50 is capable of adjusting the specified position in the direction of extension. The adjustment tool 50 includes a protruding portion 52, a rod-shaped member 54, and an abutting portion 56.

The protruding portion 52 protrudes from the slider 46. The protruding portion 52 is provided at an end part of the slider 46 in the mold clamping direction, and protrudes toward the installation surface 12F of the machine base 12. Alternatively, the protruding portion 52 may protrude in a direction other than the direction toward the installation surface 12F of the machine base 12, such as an in-plane direction of the plane perpendicular to the direction of extension in which the tie bars 28 extend. Further, the protruding portion 52 may be formed integrally with the slider 46, or may be formed separately from the slider 46. A threaded hole 52A is formed in the protruding portion 52 along the direction of extension in which the tie bars 28 extend.

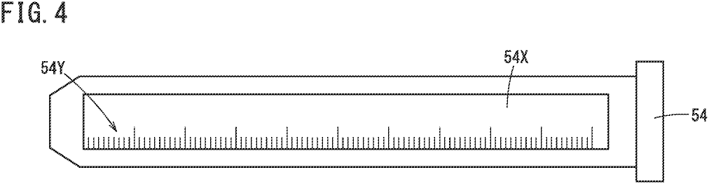

The rod-shaped member 54 is screw-engaged in the threaded hole 52A of the protruding portion 52. The rod-shaped member 54 may be a scale-equipped screw member, as shown in FIG. 4. Moreover, on a portion of the outer circumference of the screw, the scale-equipped screw member (the rod-shaped member 54) includes a flat portion 54X that extends along the direction of extension of the screw. The flat portion 54X includes a scale (graduations) 54Y formed along the direction of extension of the screw.

A screw groove, which is screw-engaged in the threaded hole 52A, is formed on the outer circumferential surface of the rod-shaped member 54. A tool groove, into which a tool such as a screwdriver or a bar wrench or the like is fitted, is formed at an end part of the rod-shaped member 54 in the mold clamping direction. Moreover, as shown in FIG. 3, a head portion, which is larger than the outer diameter of the rod-shaped member 54, may be disposed on the end part in the mold clamping direction of the rod-shaped member 54, and the tool groove may be formed in the head portion. Further, as shown in FIG. 3, a nut 54A, which suppresses loosening of the rod-shaped member 54 that is screw-engaged in the threaded hole 52A, may be provided on the rod-shaped member 54. In the case that such a nut 54A is provided, loosening of the rod-shaped member 54 is suppressed by tightening with the nut 54A an end part of the protruding portion 52 that is located on a side of the mold clamping direction.

The abutting portion 56 is a member against which the rod-shaped member 54 abuts, i.e., with which the rod-shaped member 54 makes contact. The abutting portion 56 is arranged on a side closer to the stationary platen 20 than the rod-shaped member 54. The abutting portion 56 is a protrusion, which is formed on the slider supporting member 48, in a manner so as to protrude from an end surface of the slider supporting member 48 that faces in the mold clamping direction. Such a protrusion need not necessarily be provided. In the case that the protrusion is not provided, the abutting portion 56 is an end surface of the slider supporting member 48 that faces in the mold clamping direction. Alternatively, the abutting portion 56 may be an end surface of the stationary platen 20 that faces in the mold clamping direction. In the case that the abutting portion 56 is an end surface of the stationary platen 20 that faces in the mold clamping direction, the amount at which the protruding portion 52 protrudes is larger than in the case in which the abutting portion 56 is the slider supporting member 48.

Next, a description will be given herein concerning a method of using the adjustment tool 50. In a state in which the tip of the injection nozzle 40 of the second injection device 18 is inserted into the insertion port 26H of the mold 26, the operator causes the rod-shaped member 54 to rotate in a forward direction or a reverse direction, and thereby places the end part of the rod-shaped member 54 that faces in the mold opening direction, in contact with the abutting portion 56. The position of the slider 46 when the rod-shaped member 54 is placed in contact with the abutting portion 56 is the specified position. In a state in which the position of the slider 46 is at the specified position, the injection nozzle 40 and the insertion port 26H of the mold 26 are in a state in which there is no misalignment between the positions thereof in the direction of extension in which the tie bars 28 extend. In this state, the operator stops the rotation of the rod-shaped member 54. Consequently, the position where the rotation of the rod-shaped member 54 is stopped is fixed. In the case that the nut 54A is provided on the rod-shaped member 54, the operator tightens the nut 54A. Consequently, loosening of the rod-shaped member 54 is suppressed.

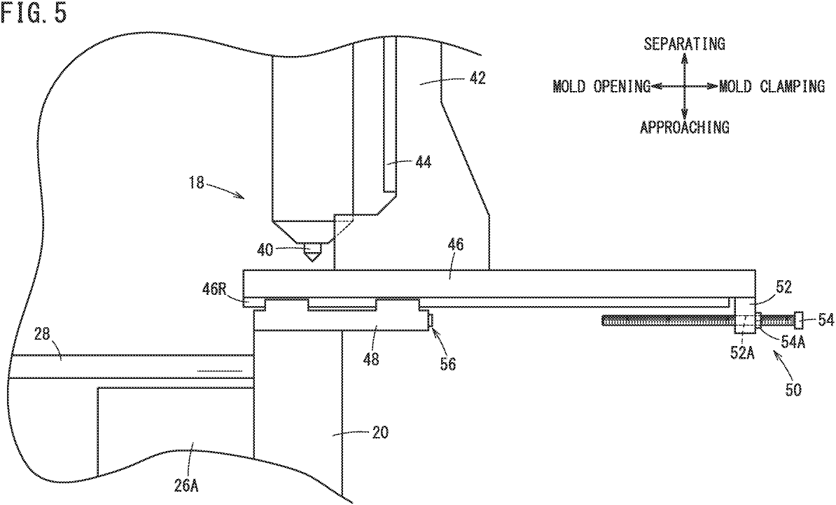

FIG. 5 is a schematic view showing a situation in which the second injection device 18 is retracted. In the case that an operation such as inspection or replacement or the like of the mold 26 is carried out, the operator causes the slider 46 to slide in a rearward direction of the mold 26, in a manner so that the second injection device 18 separates away from the mold 26. More specifically, the operator causes the second injection device 18 to move in the separating direction, and thereafter, causes the slider 46 to move in the mold clamping direction. Moreover, since the position at which the rotation of the rod-shaped member 54 is stopped is fixed, even if the slider 46 is slid rearwardly of the mold 26, the length of the rod-shaped member 54 that extends from the protruding portion 52 in the mold opening direction does not change.

In the case that the operation such as inspection or replacement or the like of the mold 26 is completed, the operator returns the second injection device 18 to its original position. More specifically, the operator causes the slider 46 to move in the mold clamping direction. In accordance with the movement of the slider 46, by the end part of the rod-shaped member 54 that faces in the mold opening direction being placed in contact with the abutting portion 56, the abutting portion 56 (the slider supporting member 48) restricts the movement of the slider 46 in a manner so that the slider 46 does not slide in the mold opening direction of the mold 26 (refer to FIG. 3).

As described above, even if the slider 46 is slid rearwardly of the mold 26, the length of the rod-shaped member 54 that extends from the protruding portion 52 toward the mold opening direction does not change. Therefore, at the position (the specified position) of the slider 46 when the rod-shaped member 54 is placed in contact with the abutting portion 56, the injection nozzle 40 and the insertion port 26H of the mold 26 are in a state in which there is no misalignment between the positions thereof in the direction of extension in which the tie bars 28 extend. In other words, the slider 46 can be returned to the specified position by a simple operation of the operator causing the slider 46 to slide until the rod-shaped member 54 is placed in contact with the abutting portion 56.

In the foregoing manner, the adjustment tool 50 maintains the length of the rod-shaped member 54 that, when the rod-shaped member 54 is placed in contact with the abutting portion 56, extends from the protruding portion 52 in the mold opening direction. Accordingly, the injection position of the second injection device 18 with respect to the mold 26 can be maintained (remembered).

Incidentally, cases may occur in which the injection position of the second injection device 18 changes due to circumstances such as replacement or the like of the mold 26. In this case, the operator rotates the rod-shaped member 54 in the forward direction or the reverse direction, whereby the position (the specified position) of the slider 46 at the time when the rod-shaped member 54 is placed in contact with the abutting portion 56 can be adjusted in the direction of extension in which the tie bars 28 extend. Moreover, in the case that the rod-shaped member 54 is a scale-equipped screw (see FIG. 4), the operator is capable of recording, by using the scale 54Y of the scale-equipped screw, the injection position of the second injection device 18 with respect to each of a plurality of molds 26 that have been replaced in the past. Accordingly, at a time when the mold 26 is returned to the original mold 26 or the like, the slider 46 can be easily returned to the specified position.

### Modifications

### Modification 1

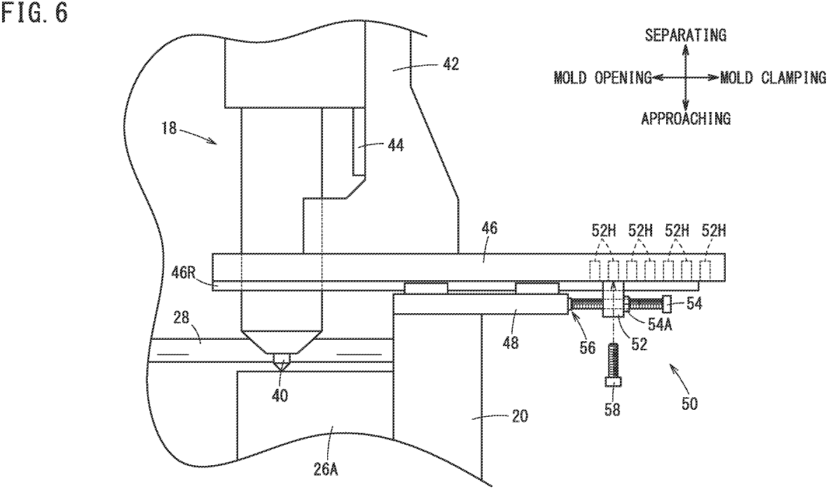

FIG. 6 is a schematic view of a portion of a side surface of the injection molding machine 10 according to a first modification. In FIG. 6, the same reference numerals are used to designate constituent elements that are the same as those described in the embodiment. Further, in the present modification, descriptions that are duplicative of those given in the embodiment will be omitted.

In the slider 46 according to the first modification, a plurality of threaded holes 52H are formed at an interval in the direction of extension in which the tie bars 28 extend. Each of the plurality of threaded holes 52H accepts a fastener 58 such as a bolt or the like for fixing the protruding portion 52 to the slider 46. Therefore, according to the present modification, the installation position of the protruding portion 52 can be changed. For example, in the case that the thickness of the stationary platen 20 is changed, an appropriate installation position of the protruding portion 52 can be selected in accordance with such a thickness.

Further, according to the present modification, the protruding portion 52 can be disposed on a portion of the slider 46 that is closer to the stationary platen 20 than the end part of the slider 46 in the mold clamping direction of the mold 26. In the case where the protruding portion 52 is disposed on the portion of the slider 46 that is closer to the stationary platen 20 than the end part of the slider 46 in the mold clamping direction of the mold 26, the length of the rod-shaped member 54 can be made smaller, in comparison with a case in which the protruding portion 52 is disposed at the end part. Accordingly, it is possible to reduce the space occupied by the adjustment tool 50. Moreover, the protruding portion 52 according to the embodiment may be disposed on a portion of the slider 46 that is closer to the stationary platen 20 than the end part of the slider 46 in the mold clamping direction of the mold 26.

### Modification 2

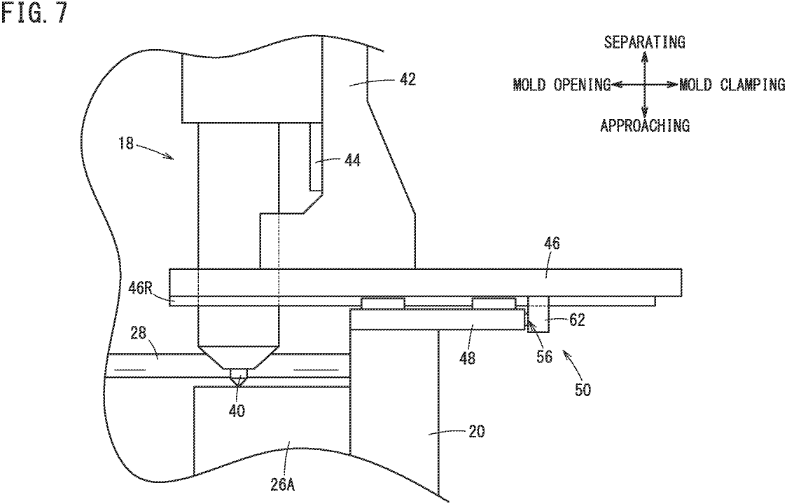

FIG. 7 is a schematic view of a portion of a side surface of the injection molding machine 10 according to a second modification. In FIG. 7, the same reference numerals are used to designate constituent elements that are the same as those described in the embodiment. Further, in the present modification, descriptions that are duplicative of those given in the embodiment will be omitted.

According to the second modification, the rod-shaped member 54 is not provided, and instead of the protruding portion 52, a protruding portion 62 is provided, which is capable of being attached to and detached from the slider 46. Since the rod-shaped member 54 is not provided, the protruding portion 62 has no member corresponding to the threaded hole 52A of the protruding portion 52, and the protruding portion 62 is placed in contact with the abutting portion 56. The protruding portion 62 includes a magnet, and is attached to the slider 46 by the magnetic force of the magnet. Due to being attached to the slider 46, the protruding portion 62 protrudes from the slider 46. Moreover, a threaded hole need not necessarily be formed in the protruding portion 62 along the direction of extension in which the tie bars 28 extend. Further, a handle for gripping the protruding portion 62 may be provided on the protruding portion 62.

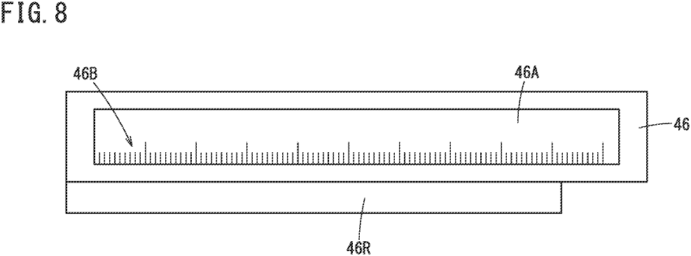

Further, as shown in FIG. 8, a scale member 46A may be provided on the slider 46. Such a scale member 46A may be provided on the slider 46 by way of screw-fixation, or may be provided thereon by attaching the scale member 46A with an adhesive tape. Further, the scale member 46A may be provided on the slider 46 by attracting the same to the slider 46 using a magnetic force of a magnet, or may be formed directly thereon by way of machining. In the case that the scale member 46A is provided on the slider 46, scale (graduations) 46B of the slider 46 is arranged along the direction of extension in which the tie bars 28 extend.

Next, a case will be described concerning a method of using the adjustment tool 50 according to the second modification. In a state in which the tip of the injection nozzle 40 of the second injection device 18 is inserted into the insertion port 26H of the mold 26, the operator attaches the protruding portion 62 to the slider 46 with the protruding portion 62 being in contact with the abutting portion 56. The position of the slider 46 at this time is the specified position.

Thereafter, in the case that an operation such as inspection or replacement or the like of the mold 26 is carried out, the operator causes the slider 46 to slide rearwardly of the mold 26, in a manner so that the second injection device 18 separates away from the mold 26. Moreover, since the protruding portion 62 is attached to the slider 46, the attached position of the protruding portion 62 with respect to the slider 46 does not change, even if the slider 46 is slid rearwardly of the mold 26.

In the case that the operation such as inspection or replacement or the like of the mold 26 is completed, the operator causes the slider 46 to move in the mold opening direction. In response to such movement of the slider 46, the protruding portion 62 is placed in abutment against (i.e., contact with) the abutting portion 56. Consequently, the abutting portion 56 (the slider supporting member 48) is capable of restricting movement of the slider 46 in a manner so as not to slide in the mold opening direction of the mold 26.

In the foregoing manner, even if the slider 46 is slid rearwardly of the mold 26, the attached position of the protruding portion 62 with respect to the slider 46 is not changed. Therefore, at the position (the specified position) of the slider 46 when the protruding portion 62 is placed in contact with the abutting portion 56, the injection nozzle 40 and the insertion port 26H of the mold 26 are in a state in which there is no misalignment between the positions thereof in the direction of extension in which the tie bars 28 extend. In other words, the slider 46 can be returned to the specified position by a simple operation of the operator causing the slider 46 to slide until the protruding portion 62 is placed in contact with the abutting portion 56.

In this manner, by maintaining the attached position of the protruding portion 62 with respect to the slider 46, the adjustment tool 50 is capable of maintaining (remembering) the injection position of the second injection device 18 with respect to the mold 26. Further, according to the present modification, since the rod-shaped member 54 of the embodiment can be eliminated, the number of constituent parts can be reduced, and it is possible to reduce the space occupied by the adjustment tool 50.

Incidentally, cases may occur in which the injection position of the second injection device 18 changes due to circumstances such as replacement or the like of the mold 26. In this case, the operator changes the attached position of the protruding portion 62 with respect to the slider 46. Consequently, the position (the specified position) of the slider 46 at the time when the protruding portion 62 is placed in contact with the abutting portion 56 can be adjusted in the direction of extension in which the tie bars 28 extend. Moreover, in the case that the scale member 46A is provided on the slider 46 (see FIG. 8), the operator is capable of recording, by using the scale 46B of the scale member 46A, the injection position of the second injection device 18 with respect to each of a plurality of molds 26 that have been replaced in the past. Accordingly, at a time when the mold 26 is returned to the original mold 26 or the like, the slider 46 can be easily returned to the specified position.

### Modification 3

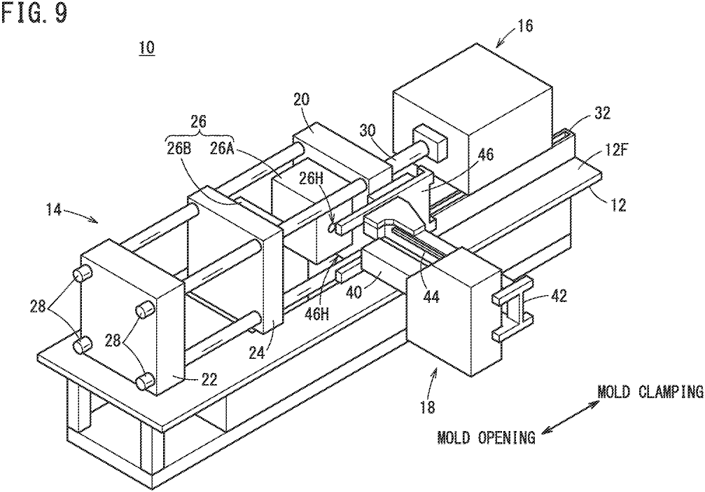

FIG. 9 is a schematic view of the injection molding machine 10 according to a third modification. In FIG. 9, the same reference numerals are used to designate constituent elements that are the same as those described in the embodiment. Further, in the present modification, descriptions that are duplicative of those given in the embodiment will be omitted.

According to the third modification, the second injection device 18 is provided on one of side surfaces of the stationary platen 20. The side surfaces of the stationary platen 20 are surfaces other than a surface of the stationary platen 20 that faces in the mold clamping direction, a surface thereof that faces in the mold opening direction, the installation surface 12F of the machine base 12, or a surface opposite to the installation surface 12F of the machine base 12. In other words, the side surfaces of the stationary platen 20 are surfaces parallel to the direction of extension in which the tie bars 28 extend, and are surfaces other than the installation surface 12F of the machine base 12 or the surface opposite to the installation surface 12F of the machine base 12. The slider 46 is provided on such a side surface of the stationary platen 20, and the second injection device 18 is supported by the support member 42 which is installed on the slider 46.

Moreover, in the case that the second injection device 18 is disposed on the side surface of the stationary platen 20, the insertion port 26H into which the tip of the injection nozzle 40 of the second injection device 18 is inserted is disposed on a side surface of the mold 26 that is on the same side as the side surface of the stationary platen 20.

In the foregoing manner, even if the second injection device 18 is disposed on the side surfaces of the stationary platen 20, similar to the case of the above-described embodiment, the slider 46 is capable of being returned to the specified position by the adjustment tool 50.

### Modification 4

Although the injection molding machine 10 is installed on the machine base 12, the injection molding machine 10 may also be installed on a wall that extends in a vertical direction. In greater detail, although the injection molding machine 10 is installed on the installation surface 12F which is arranged in the horizontal direction, the injection molding machine 10 may be installed on an installation surface arranged in a direction that intersects with the horizontal direction, or may be installed on an installation surface that is arranged in the vertical direction.

### Modification 5

The first injection device 16 may be omitted. In the case that the first injection device 16 is omitted, the resin is ejected only from the second injection device 18.

### Modification 6

The above-described embodiment and the modifications thereof may be optionally combined within a range in which no technical inconsistencies occur.

### Inventions

The inventions that can be grasped from the above-described embodiment and the modifications thereof will be described below.

The present invention is characterized by the injection molding machine (10) which opens and closes the mold (26) by moving the movable platen (24) relative to the stationary platen (20) along the tie bars (28) that are connected to the stationary platen (20), the injection molding machine (10) being equipped with the injection device (18) that injects the resin into the mold (26) from a direction that intersects with the direction of extension in which the tie bars (28) extend, the slider (46) that supports the injection device (18), and which is configured to slide relative to the stationary platen (20) along the direction of extension, and the adjustment tool (50) disposed on the side of the stationary platen (20) opposite to the side on which the mold (26) is disposed, the adjustment tool (50) being configured to restrict movement of the slider (46) in a manner so that the slider (46) does not slide, relative to the stationary platen (20), in the mold opening direction of the mold (26) beyond the specified position, the adjustment tool (50) being also configured to adjust the specified position in the direction of extension.

In accordance with such features, even if the slider (46) is made to slide away from the mold (26), the slider (46) is capable of being returned to the specified position by the adjustment tool (50), and as a result, variations in the position of the slider (46) with respect to the specified position can be reduced.

The adjustment tool (50) may include the protruding portion (52) that protrudes from the slider (46), the rod-shaped member (54) configured to be screw-engaged in the threaded hole (52A) that is formed in the protruding portion (52) along the direction of extension, and the abutting portion (56) which is arranged on the side closer to the stationary platen (20) than the rod-shaped member (54), and with which the rod-shaped member (54) makes contact, wherein the position of the slider (46) when the rod-shaped member (54) is placed in contact with the abutting portion (56) is the specified position. In accordance with such features, the slider (46) can be returned to the specified position by a simple operation of the operator causing the slider (46) to slide until the rod-shaped member (54) is placed in contact with the abutting portion (56).

The protruding portion (52) may be disposed on a portion of the slider that is closer to the stationary platen (20) than the end part of the slider (46) in the mold clamping direction of the mold (26). In accordance with this feature, the length of the rod-shaped member (54) can be made smaller, in comparison with a case in which the protruding portion (52) is disposed on the end part of the slider (46) in the mold clamping direction of the mold (26), and as a result, it is possible to reduce the space occupied by the adjustment tool (50).

The rod-shaped member (54) may include the flat portion (54X) that extends along the direction of extension of the rod-shaped member (54), and the flat portion (54X) may include the scale (54Y) arranged along the direction of extension. In accordance with this feature, the injection position of the second injection device (18) with respect to each of a plurality of molds (26) that have been replaced in the past can be recorded by using the scale (54Y). Accordingly, at a time when the mold is returned to the original mold (26) or the like, the slider (46) can be easily returned to the specified position.

The plurality of threaded holes (52H) may be formed in the slider (46), and the threaded holes (52H) are spaced at an interval in the direction of extension, and accept the fastener (58) configured to fix the protruding portion (52) to the slider (46). Due to this feature, it is possible to change the installation position of the protruding portion (52). For example, in the case that the thickness of the stationary platen (20) is changed, an appropriate installation position of the protruding portion (52) can be selected in accordance with such a thickness.

The adjustment tool (50) may include the protruding portion (62) that is attachable to and removable from the slider (46), and which protrudes from the slider (46) by being attached to the slider (46), and the abutting portion (56) which is arranged on a side closer to the stationary platen (20) than the protruding portion (62), and with which the protruding portion (62) makes contact, wherein the position of the slider (46) when the protruding portion (62) is placed in contact with the abutting portion (56) may be the specified position. In accordance with such features, the slider (46) can be returned to the specified position by a simple operation of the operator causing the slider (46) to slide until the protruding portion (62) is placed in contact with the abutting portion (56).

The slider (46) may include the scale (46B) arranged along the direction of extension. In accordance with this feature, the injection position of the second injection device (18) with respect to each of a plurality of molds (26) that have been replaced in the past can be recorded by using the scale (46B). Accordingly, at a time when the mold is returned to the original mold (26) or the like, the slider (46) can be easily returned to the specified position.

The abutting portion (56) may be a slider supporting member (48) that slidably supports the slider (46). It is possible to reduce the number of constituent parts, in comparison with a case in which the abutting portion (56) and the slider supporting member (48) are separate members.

1. An injection molding machine configured to open and close a mold by moving a movable platen relative to a stationary platen along a tie bar that is connected to the stationary platen, the injection molding machine comprising:
an injection device configured to inject a resin into the mold from a direction that intersects with a direction of extension in which the tie bar extends;
a slider configured to support the injection device and to slide relative to the stationary platen along the direction of extension; and
an adjustment tool disposed on a side of the stationary platen opposite to a side on which the mold is disposed, the adjustment tool being configured to restrict movement of the slider in a manner so that the slider does not slide, relative to the stationary platen, in a mold opening direction of the mold beyond a specified position, the adjustment tool being also configured to adjust the specified position in the direction of extension.

2. The injection molding machine according to claim 1, wherein the adjustment tool comprises:
a protruding portion that protrudes from the slider;
a rod-shaped member configured to be screw-engaged in a threaded hole that is formed in the protruding portion along the direction of extension; and
an abutting portion arranged on a side closer to the stationary platen than the rod-shaped member, and with which the rod-shaped member makes contact;
wherein a position of the slider when the rod-shaped member is placed in contact with the abutting portion is the specified position.

3. The injection molding machine according to claim 2, wherein the protruding portion is disposed on a portion of the slider that is closer to the stationary platen than an end part of the slider in a mold clamping direction of the mold.

4. The injection molding machine according to claim 2, wherein the rod-shaped member includes a flat portion that extends along a direction of extension of the rod-shaped member, and the flat portion includes a scale arranged along the direction of extension.

5. The injection molding machine according to claim 2, wherein a plurality of threaded holes are formed in the slider, and the threaded holes are spaced at an interval in the direction of extension, and accept a fastener configured to fix the protruding portion to the slider.

6. The injection molding machine according to claim 1, wherein the adjustment tool comprises:
a protruding portion attachable to and removable from the slider, and configured to protrude from the slider by being attached to the slider; and
an abutting portion arranged on a side closer to the stationary platen than the protruding portion, and with which the protruding portion makes contact;
wherein a position of the slider when the protruding portion is placed in contact with the abutting portion is the specified position.

7. The injection molding machine according to claim 6, wherein the slider includes a scale arranged along the direction of extension.

8. The injection molding machine according to claim 2, wherein the abutting portion is a slider supporting member configured to slidably support the slider.

9. The injection molding machine according to claim 6, wherein the abutting portion is a slider supporting member configured to slidably support the slider.
